(19) United States
(12) Patent Application Publication
(10) Pub. No.: US 2024/0015829 A1
(43) Pub. Date: Jan. 11, 2024

(54) METHOD AND DEVICE FOR POWER MANAGEMENT IN WIRELESS COMMUNICATION SYSTEM SUPPORTING MULTI-RAT DUAL CONNECTIVITY STATE

(71) Applicant: SAMSUNG ELECTRONICS CO., LTD., Suwon-si (KR)

(72) Inventors: Aman Agarwal, Bangalore (IN); Kailash Kumar Jha, Bangalore, IN (US); Nishant, Bangalore (IN); Satya Prakash, Bangalore (IN)

(21) Appl. No.: 18/345,312

(22) Filed: Jun. 30, 2023

Related U.S. Application Data
(63) Continuation of application No. PCT/KR2023/009182, filed on Jun. 29, 2023.

(30) Foreign Application Priority Data
Jul. 1, 2022 (IN) 202241038129
May 23, 2023 (IN) 202241038129

(51) Int. Cl. H04W 76/15; H04W 76/28; H04W 28/02

(52) U.S. Cl. CPC H04W 76/15; H04W 76/28; H04W 28/0268

(57) ABSTRACT

Disclosed is a method for power management of a User Equipment (UE) in multi-rat dual connectivity state. The method includes determining whether one of a first parameter or a second parameter related with an uplink data is met, when the UE is in the MR-DC state and comparing, when one of the first parameter or the second parameter is met, a value of a connected mode discontinuous reception (CDRX) configuration of a master cell group (MCG) cycle and a value of CDRX configuration cycle for a secondary cell group (SCG) cycle, wherein the UE is in the MR-DC state with the MCG and SCG. The method further includes determining an optimal CDRX configuration cycle among the MCG and the SCG based on a result of the comparison and transmitting the uplink data to a network entity over one of the MCG and SCG based on the optimal CDRX configuration cycle.

### CROSS-REFERENCE TO RELATED APPLICATIONS

This application is a continuation of International Application No. PCT/KR2023/009182 designating the United States, filed on Jun. 29, 2023, in the Korean Intellectual Property Receiving Office and claiming priorities to Indian Provisional Patent Application No. 202241038129, filed on Jul. 1, 2022, in the Indian Patent Office, and Indian Complete Patent Application Number 202241038129, filed on May 23, 2023, in the Indian Patent Office, the disclosures of each of which are incorporated by reference herein in their entireties.

### BACKGROUND

### Field

The disclosure relates to a method and a device for power management of a User Equipment (UE) in a Multi-radio Access Technology (RAT) Dual Connectivity (MR-DC) state.

### Description of Related Art

In 3^{rd} Generation Partnership Project (3GPP) Release-16 TS38.331, parameters related to the UE preferred Connected Mode Discontinuous Reception (CDRX or C-DRX) for UE power saving were introduced in Radio Resource Control (RRC) message. CDRX is configured by a network in which the UE periodically wakes up (on duration) to monitor a Physical Downlink Control Channel (PDCCH), and the UE periodically went to sleep mode (off duration) to save power in the connected mode. No downlink (DL) data is scheduled by the network during a sleep period.

According to Release-16, Discontinuous Reception (DRX)-preference Information Element (IE), the UE can request a preferred DRX configuration for a Secondary Cell Group (SCG) leg and a Master Cell Group (MCG) leg. The CDRX configuration performed by the network in the UE applies to all types of services running on the UE. In order to provide one level of flexibility to the UE, the 3GPP has introduced the DRX preference in UE Assistance information (UAI) messages in release-16 so that the UE can choose DRX cycle length to save power. There can be multiple applications running simultaneously on the UE. These multiple applications may have different Quality of Service (QoS) and priority which may require different CDRX configurations for better performance. Thus, with a 5^{th} Generation (5G) providing different categories of services, it is required to have proper CDRX configuration with power saving in the UE.

In a Multi-RAT Dual Connectivity (MRDC), when a split bearer is configured, then the network provides independent CDRX configuration to the MCG leg and the SCG leg through the RRC configuration messages. The CDRX configuration of the MCG leg and the SCG leg is of different lengths. Due to this, the UE wakes up at different durations as per configured CDRX cycle. Further, the network does not consider Uplink (UL) traffic from the UE while configuring the CDRX in the UE.

Further, the generation of frequent intermittent data by an application in UL leads the UE to wake up both RAT such as Long Term Evolution (LTE) and new radio (NR) stacks, to send data. This results in disrupting the sleep duration causing higher power consumption in the UE.

Further, if multiple applications with different QoS and priorities are running on the UE with the split bearer, then, without proper CDRX and UL data routing, higher power consumption will occur.

Additionally, few services/applications are used frequently in the UE. Even though the UE can evaluate the usage of these applications, the network may not consider the evaluation while configuring CDRX leading to higher power consumption or degraded user experience.

As per 3GPP TS 38.331, the UE-specific CDRX is configured by the network in the RRC Reconfiguration message, as shown in FIG. 1B. FIG. 1A illustrates the RRC Reconfiguration message of the UE without CDRX configuration, in accordance with existing art. As shown in FIG. 1A, the UE is continuously in wake-up mode, which increases power consumption in the UE. As shown in FIG. 1B, when CDRX is configured, the UE periodically enters wake-up mode (on duration) to monitor the PDCCH channel, and the UE periodically goes to sleep mode (off duration). In the sleep mode, the network does not schedule any DL data for the UE, and therefore PDCCH monitoring is not required in the sleep mode. Hence, the use of CDRX saves power in the connected mode. As

Referring to FIG. 1B, the DRX mode is configured in the UE using the RRC configuration message IE of drx-config setup. Further, in FIG. 1B, the DRX cycle corresponds to one of a periodic repetition of ON duration (Monitoring PDCCH) and OFF Duration (DRX activity). The DRX inactivity timer specifies the time in terms of Transmission Time Interval (TTI) duration after successfully decoded PDCCH, to go again in OFF duration. The on duration timer specifies the number of consecutive PDCCH subframe(s) that need to be decoded after wake-up from the DRX Cycle. The DRX retransmission timer specifies the consecutive number of PDCCH subframe(s) to monitor when retransmission is expected by the UE. The DRX short cycle corresponds to the first DRX cycle entered by the UE after the successful expiration of the DRX inactivity timer. UE may be in the short DRX cycle till the expiration of the DRX short cycle timer after that the UE may be in the Long DRX cycle.

Further, the DRX short cycle timer may correspond to a parameter that specifies the number of consecutive subframe(s) the UE shall follow the short DRX cycle after the DRX inactivity timer has expired.

In Release-16, the 3GPP has further introduced power-saving enhancements using the UAI message in which UE may choose the preferred DRX configuration for the SCG and MCG legs. Using the DRX-preference IE, UE may request the preferred DRX configuration for SCG and MCG leg, as shown below in Tables 1 and 2. The below-shown Tables 1 and 2 illustrates features in the UAI message and UE preferences:

TABLE 1
3GPP TS 38.331 Release-16

| | |
|---|---|
| UEAssistanceInformation-v1610-IEs :: = | SEQUENCE { |
| idc-Assistance-r16 | IDC-Assistance-r16 |

OPTIONAL,

| | |
|---|---|
| drx-Preference-r16 | DRX-Preference-r16 |

OPTIONAL,

| | |
|---|---|
| maxBW-Preference-r16 | MaxBW-Preference-r16 |

OPTIONAL,

| | |
|---|---|
| maxCC-Preference-r16 | MaxCC-Preference-r16 |

OPTIONAL,

| | |
|---|---|
| maxMIMO-LayerPreference-r16 | MaxMIMO-LayerPreference-r16 |

OPTIONAL,

| | |
|---|---|
| minSchedulingOffsetPreference-r16 | MinSchedulingOffsetPreference-r16 |

OPTIONAL,

| | |
|---|---|
| releasePreference-r16 | ReleasePreference-r16 |

OPTIONAL,

| | |
|---|---|
| sl-UE-AssistanceInformationNR-r16 | SL-UE-AssistanceInformationNR-r16 |

OPTIONAL,

| | |
|---|---|
| referenceTimeInfoPreference-r16 | BOOLEAN |

OPTIONAL,

| | |
|---|---|
| nonCriticalExtension | SEQUENCE { } |

OPTIONAL
}

TABLE 2

| Feature IE in UAI | UE Preference |
|---|---|
| DRX-Preference | DRX parameters |
| maxBW-Preference | max aggregated bandwidth |
| maxCC-Preference | max number of SCells |
| maxMIMO-LayerPreference | max number of MIMO layers |
| | per serving cell |
| minschedulingOffsetPreference | K0 & K2 |
| releasePreference | requesting connection release |

FIG. 2 is a signal flow diagram for UAI reporting based on the need for power saving in the UE, according to existing art.

Further, as per the 3GPP TS 38.323, section-5.2.1,

When submitting a packet data convergence protocol (PDCP) protocol data unit (PDU) to the lower layer, the transmitting port control protocol (PCP) entry shall:
if the transmitting PCP entity is associated with one RLC entity:
   summit the PDCP PDU to the associated RLC entity:
else, if the transmitting PCPP entity is associated with 2 RLC entities:
   if the PDCP duplication is activated:
      if the PDCP PDU is a PDCP Data PDU:
         duplicate the PDCP Data PDU and submit the PDCP Data PDU to both associated RLC entities:
      else:
         submit the PDCP Control PDU to the primary RLC entity:

| | | |
|---|---|---|
| • | else: | |
| | - | If the two associated RLC entities belong to different cell groups; |
| | | and |
| | - | if the total amount of PDCP data volume and RLC data volume |
| | | pending for initial transmission (as specified in TS 38.322 [5]) in |
| | | the two associated RLC entities is equal to or larger than ul- |
| | | DataSplitThreshold: |

submit the PDCP PDU to either the primary RLC entity or the secondary RLC entity:
else:
   submit the PC PSU to the primary RLC entity.

As per 3GPP specification, if ul-DataSplitThreshold is configured by the network, then the UE needs to send data over a primary and a secondary path when data volume exceeds the threshold limit.

5G networks aim to boost the digital transformation of a variety of industry verticals such as enhanced mobile broadband (eMBB), ultra-reliable low-latency communication (uRLLC), and massive machine-type communication (mMTC). These verticals provide a wide variety of unprecedented services with diverging requirements in terms of functionality and performance.

5G provides a QoS class identifier (QCI) mechanism. In QCI, each QoS class has its characteristics like packet loss and packet latency. Every packet is classified into different QoS classes as per the service requirement. QoS plays a key role in differentiating the packets, which are dictated by policy. Some applications such as voice/video calling have frequent and periodic receiving/transmitting (Rx/Tx) operations, whereas some applications have intermittent small data. Similarly, applications like ultra-high definition (UHD)/8K/4K video, virtual reality (VR), and augmented reality (AR) require frequent and higher chunks of data. Accordingly, application latency sensitivity, throughput requirements, and priority of Rx/Tx classify the applications into different QoS classes. QoS is a flow based where each packet is identified by a QoS flow identifier (QFI). QoS flows are mapped in the network to data radio bearers (DRBs).

Further, with 5G deployments, dual connectivity, and larger bandwidth cells are used which increase the power consumption in devices drastically. So, reducing power consumption is a focus in 5G to enhance battery life and smooth user experience.

In dual connectivity, the UE is configured with UL/DL split bearer. So, UE can route and receive data in both MCG as well as SCG legs. The network configures MCG and SCG with different CDRX cycle lengths because MCG and SCG are served using different gNodeB (gNBs)/eNodeB (eNBs). So, one CDRX cycle will be smaller than the other CDRX cycle.

Additionally, these CDRX configurations are not in sync, which may refer, for example, to there being occasions where the MCG leg is sleeping during the CDRX cycle and the SCG leg is in the wake-up condition to monitor PDCCH and vice versa. For example, an application is running in the UE which generates small UL data intermittently which may refer, for example, to UL transmission happening frequently by the UE. The network does not consider this UL traffic/data while configuring CDRX. Accordingly, in such cases of frequent intermittent data, the UE wakes up both of the networks such as LTE and NR stacks to send the data. This results in disrupting the sleep duration intermittently causing higher power consumption in UE.

In another example, multiple applications with different QoS and priorities are running simultaneously in the UE. These application data are scheduled on both legs (MCG and SCG) without considering the CDRX values configured by the network in the UE. There is a possibility that these application data are not heavily UL oriented, but rather are intermittent data. So, in these cases as well, UE does not consider CDRX configuration along with UL data priority and traffic pattern while transmitting UL data. This leads to higher power consumption in the UE as the UE wakes up intermittently to send the data, as shown in FIG. 3.

Additionally, few services/applications are used frequently in the UE. Even though the UE can evaluate the usage of these applications, the network may not consider the evaluation while configuring CDRX leading to higher power consumption or degraded user experience.

Hence, there is a need in the art to provide techniques that overcome the above-discussed problems.

### SUMMARY

This summary is not intended to identify key or essential concepts of the disclosure, nor is it intended for determining the scope of the disclosure.

The present disclosure provides a method and device for efficient power management in a wireless communication system supporting a multi-RAT dual connectivity state.

According to an example embodiment, a method for power management of a user equipment (UE) in a wireless communication system supporting a multi-radio access technology (RAT) dual connectivity (MR-DC) state is provided. The method includes determining whether one of a first parameter or a second parameter is met, wherein each of the first parameter and the second parameter relates to an uplink data to be transmitted by the UE based on the UE being in the MR-DC state. The method further includes comparing, based on one of the first parameter or the second parameter being met, a value of a connected mode discontinuous reception (CDRX) configuration of a master cell group (MCG) cycle and a value of CDRX configuration cycle for a secondary cell group (SCG) cycle, wherein the UE is in the MR-DC state with the MCG and SCG. The method includes determining a CDRX configuration cycle among the MCG and the SCG based on a result of the comparison and transmitting the uplink data to a network entity over one of the MCG and SCG based on the determined CDRX configuration cycle.

According to an example embodiment, a user equipment (UE) in a wireless communication system supporting a multi-radio access technology (RAT) dual connectivity (MR-DC) state, is disclosed. The UE comprises: a transceiver, and a processor. The processor is configured to determine whether one of a first parameter or a second parameter is met, wherein each of the first parameter and the second parameter relates to an uplink data to be transmitted by the UE, based on the UE being in the MR-DC state. The processor is further configured to compare, based on one of the first parameter or the second parameter being met, a value of a connected mode discontinuous reception (CDRX) configuration of a master cell group (MCG) cycle, and a value of CDRX configuration cycle for a secondary cell group (SCG) cycle, wherein the UE is in the MR-DC state with the MCG and SCG. The processor is also configured to determine a CDRX configuration cycle among the MCG and the SCG based on a result of the comparison and transmit, through the transceiver, the uplink data to a network entity over one of the MCG and SCG based on the determined CDRX configuration cycle. According to an example embodiment, a non-transitory computer readable storage medium may include one or more programs is disclosed, the one or more programs comprising instructions configured to, when executed by at least one processor of a UE, cause the UE in a wireless communication system supporting a multi-radio access technology (RAT) dual connectivity (MR-DC) state, to determine whether one of a first parameter or a second parameter is met, wherein each of the first parameter and the second parameter relates to an uplink data to be transmitted by the UE based on the UE being in the MR-DC state, to compare, based on one of the first parameter or the second parameter being met, a value of a connected mode discontinuous reception (CDRX) configuration of a master cell group (MCG) cycle and a value of CDRX configuration cycle for a secondary cell group (SCG) cycle, wherein the UE is in the MR-DC state with the MCG and SCG, and to determine a CDRX configuration cycle among the MCG and the SCG based on a result of the comparison and transmitting the uplink data to a network entity over one of the MCG and SCG based on the determined CDRX configuration cycle.

To further clarify the advantages and features of the present disclosure, a more detailed description will be rendered with reference to various example embodiments thereof, which are illustrated in the appended drawings. It is appreciated that these drawings depict only example embodiments and are therefore not to be considered limiting its scope.

### BRIEF DESCRIPTION OF THE DRAWINGS

These and other features, aspects, and advantages of the present disclosure will be more apparent from the following detailed description, taken in conjunction with the accompanying drawings in which like characters represent like parts throughout the drawings, and in which:

FIGS. 1A and 1B are diagrams illustrating an RRC Reconfiguration message of the UE respectively with and without CDRX configuration, in accordance with existing art;

FIG. 2 is a signal flow diagram illustrating example UAI reporting based on the need for power saving in the UE, in accordance with existing art;

FIG. 3 is a diagram illustrating the high power consumption of UE in CDRX configuration, in accordance with existing art;

FIG. 4 is a diagram illustrating a CDRX cycle for MCG and SCG legs depicting intermittent UL data scheduling, in accordance with existing art;

FIG. 5 is a flowchart illustrating an example method for power management of a user equipment (UE) in a multi-radio access technology (RAT) dual connectivity (MR-DC) state, according to various embodiments;

FIG. 6 is a signal flow diagram illustrating example power management of a user equipment while transmitting intermittent UL data, according to various embodiments;

FIG. 7 is a graph illustrating transmitted intermittent UL data in a CDRX configuration, according to various embodiments;

FIG. 8 is a flowchart illustrating an example method for power management of a UE in a multi-RAT MR-DC state, according to various embodiments;

FIG. 9A is a diagram illustrating CDRX cycle configuration for MCG and SCG leg for transmission of priority UL data, in accordance with existing art;

FIG. 9B is a diagram illustrating transmission of priority UL data in CDRX configuration, in accordance with existing art;

FIG. 10A is a diagram illustrating an example CDRX cycle configuration for MCG and SCG leg for transmission of priority UL data, according to various embodiments;

FIG. 10B is a diagram illustrating example transmission of priority UL data in CDRX configuration, according to various embodiments;

FIG. 11 is a signal flow diagram illustrating an example of data PDU scheduling in CDRX configuration, according to various embodiments;

FIG. 12 is a flowchart illustrating an example method for power management of a UE in a multi-RAT MR-DC state, according to various embodiments;

FIG. 13 is a block diagram illustrating use of Artificial Intelligence (AI)/Machine Learning (ML) to determine a preferred CDRX from a network, according to various embodiments;

FIG. 14 is a flowchart illustrating an example method for determining a preferred CDRX from a network using AI/ML, according to various embodiments; and

FIG. 15 is a block diagram illustrating an example configuration of a UE for power management in an MR-DC state, according to various embodiments.

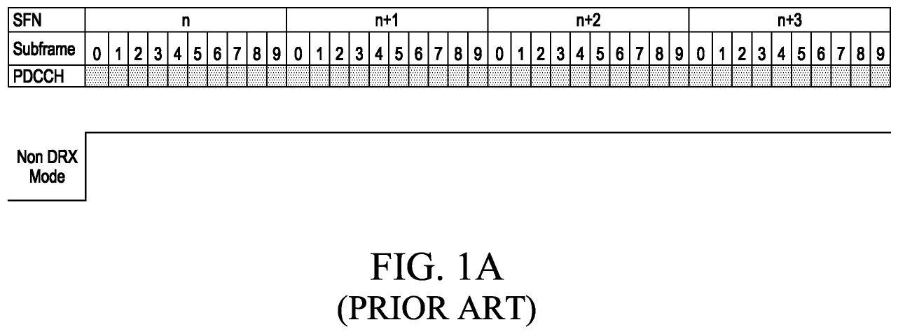

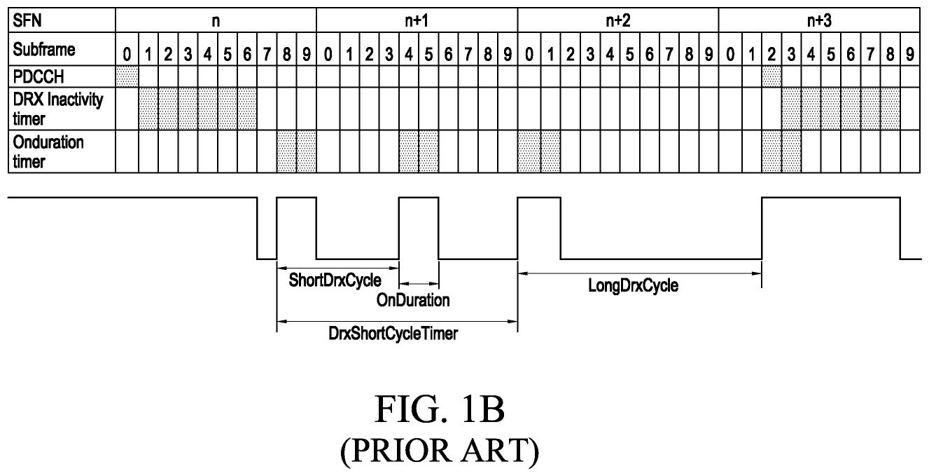

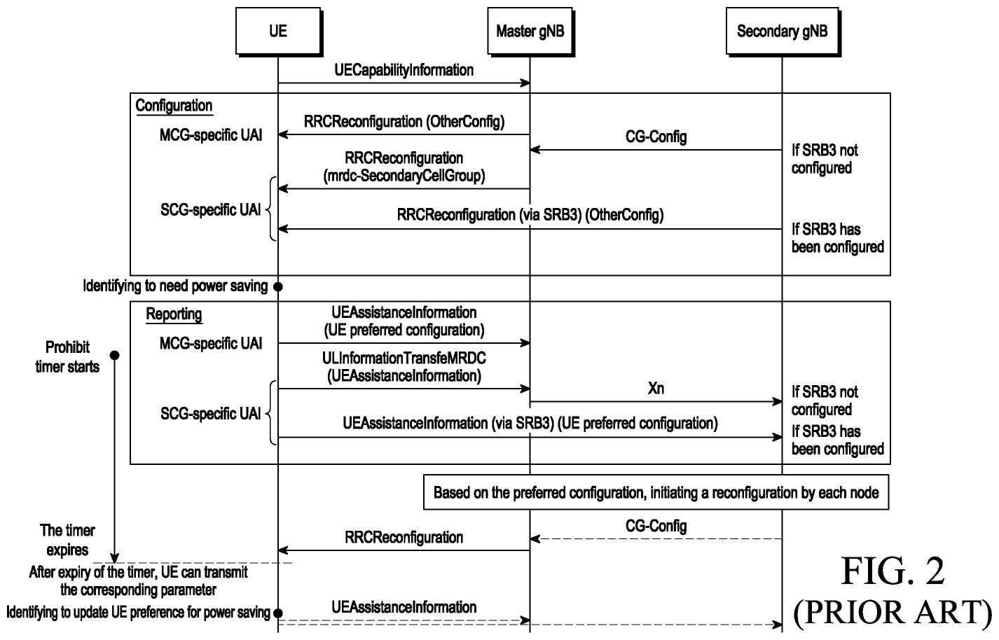

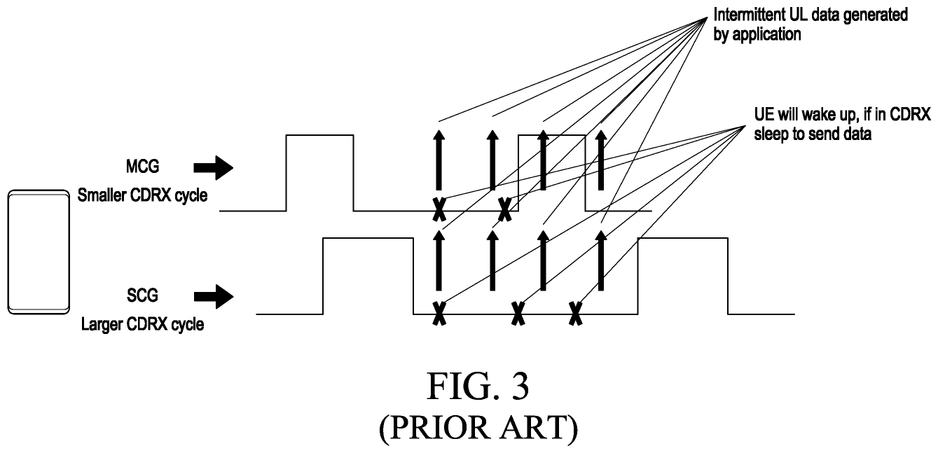

Further, skilled artisans will appreciate that elements in the drawings are illustrated for simplicity and may not have been necessarily drawn to scale. For example, the flowchart illustrate example methods in terms of the operations involved to help to improve understanding of aspects of the present disclosure. Furthermore, in terms of the construction of the UE, one or more components of the UE may have been represented in the drawings by conventional symbols, and the drawings may show specific details that are pertinent to understanding the various example embodiments of the present disclosure so as not to obscure the drawings with details that will be readily apparent to those of ordinary skill in the art having the benefit of the description herein.

### DETAILED DESCRIPTION

For the purpose of aiding in understanding of the principles of the disclosure, reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with the embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more systems or sub-systems or elements or structures or components proceeded by “comprises . . . a” does not, without more constraints, preclude the existence of other systems or other sub-systems or other elements or other structures or other components or additional systems or additional sub-systems or additional elements or additional structures or additional components. As used herein, each of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

It should be noted that the terms “stack” and “leg” have been used interchangeably throughout the disclosure.

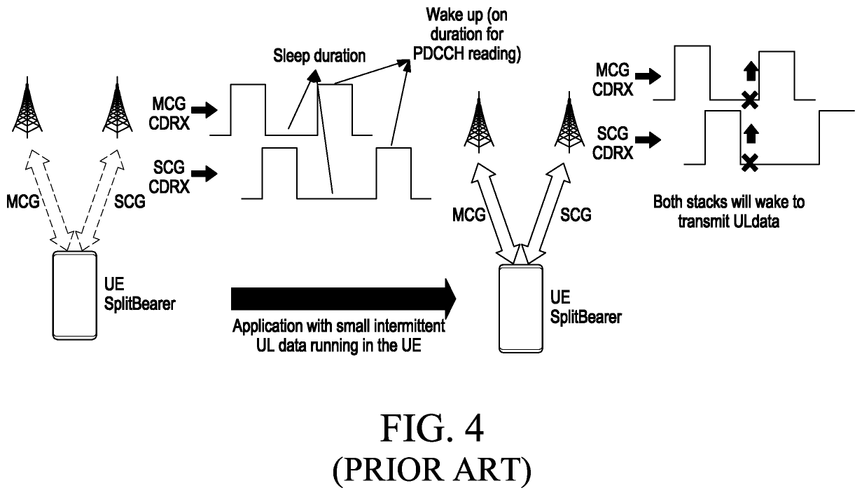

FIG. 4 is a diagram illustrating a CDRX cycle for MCG and SCG legs depicting intermittent UL data scheduling, in accordance with existing art. As shown in FIG. 4, the UE is in dual connectivity with UL/DL split bearer. The network has configured MCG and SCG with different CDRX cycle lengths because MCG and SCG are served using different g-NodeB(gNBs)/e-NodeB(eNBs). Let us assume that the MCG CDRX cycle is smaller than the SCG CDRX cycle, as shown in FIG. 4. An application is running in the UE which generates UL data intermittently which may refer, for example, to UL transmission happening frequently by the UE. So, whenever the UE has to send the UL data, the UE needs to wake up both of its stacks, e.g., SCG and MCG stacks, irrespective of the CDRX sleep cycle, to transmit the UL packet. Since the data frequency is intermittent, so the wake-up will be frequent causing frequent sleep disruption. Although the data could be below a split threshold, which can be sent via one leg, e.g., either SCG or MCG, both legs will be in wake-up mode for UL transmission causing higher power consumption in the UE.

The present disclosure addresses the above-mentioned problems. According to various embodiments of the present disclosure, methods, and devices to reduce the power consumption of the UE in a multi-RAT dual connectivity (MR-DC) state, are disclosed. In an embodiment, MR-DC refers to a range of different dual connectivity configuration options, largely associated with 5G or higher generation wireless communication system. With MR-DC, a Master RAN Node functions as the controlling entity, utilizing a secondary RAN for additional data capacity. Example MR-DC configurations may include E-UTRA-NR Dual Connectivity (EN-DC), New Radio Dual Connectivity (NR-DC), NG-RAN-E-UTRA Dual Connectivity (NGEN-DC) and NR-E-UTRA Dual Connectivity (NE-DC) etc. It should be noted that any other dual connectivity configuration shall be considered an example of MR-DC and will fall well within the scope of the present disclosure. In an embodiment, the best possible or preferred CDRX configuration for MCG or SCG is intelligently decided based on certain parameters such as uplink data pattern, frequency of PDCP service data unit (SDU), a priority of data, tokens based on QCI, and guaranteed bit rate (GBR) values, etc. The UE may request the intelligently decided CDRX configuration using a DRX-preference feature and the “on-duration cycle” of a physical downlink control channel (PDCCH) decoding may be minimized and/or reduced, in either leg e.g., MCG or SCG by scheduling lower priority data to the leg with higher DRX timer or higher priority data to the leg with lower DRX timer.

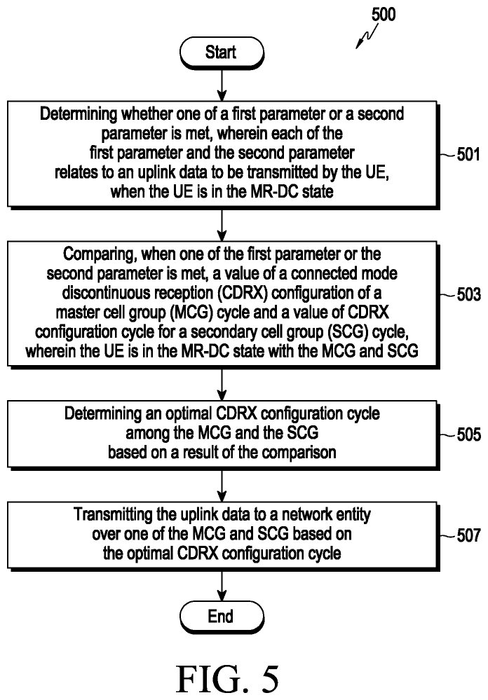

The disclosed techniques are explained in greater detail below with reference to FIGS. 5-15. It should be noted that the methods described in reference to FIGS. 5-15 may be performed by the UE. It should be noted that the term “UE” may refer to any electronic device used by a user such as a mobile device, a desktop, a laptop, a personal digital assistant (PDA), or similar devices.

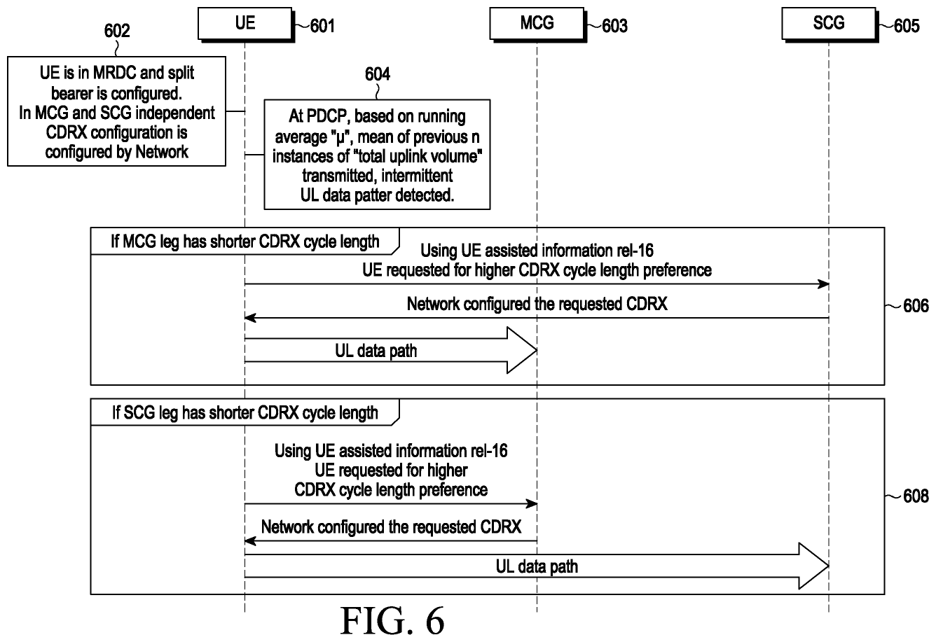

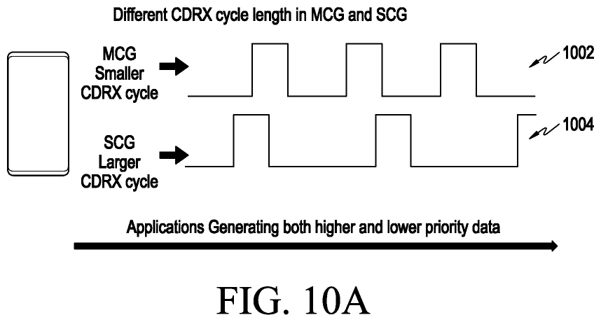

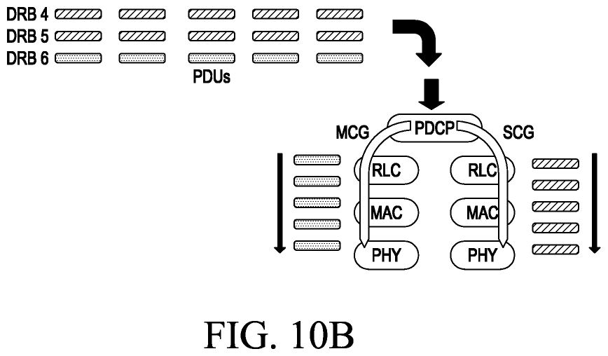

FIG. 5 is a flowchart illustrating an example method 500 for power management of a user equipment (UE) in a multi-radio access technology (RAT) dual connectivity (MR-DC) state, according to various embodiments. As shown in FIG. 5, at step 501, the method 500 may comprise determining whether one of a first parameter or a second parameter is met. In an embodiment, each of the first parameter and the second parameter relates to an uplink (UL) data to be transmitted by the UE, when the UE is in the MR-DC state. In a further embodiment, the first parameter may correspond to a volume of the uplink data and the second parameter may correspond to the priority level of the uplink data. In an embodiment, step 501 may be performed based on the volume of the UL data, which is further explained in greater detail below with reference to FIGS. 6-8. In an embodiment, step 501 may be performed based on the priority level of the UL data, which is further explained in detail in reference to FIGS. 10A-12.

At step 503, the method 500 may comprise comparing, a value of a connected mode discontinuous reception (CDRX) configuration of an MCG cycle and a value of the CDRX configuration cycle for an SCG cycle, when one of the first parameter or the second parameter is met. It should be noted that the UE is in the MR-DC state with the MCG and SCG.

At step 505, the method 500 may comprise determining an optimal and/or improved or preferred CDRX configuration cycle among the MCG and the SCG based on a result of the comparison. In an embodiment, the optimal/improved/preferred CDRX configuration cycle corresponds to one of the MCG and SCG with a lower CDRX cycle value. For example, if the CRDX cycle value of MCG is lower than the CDRX cycle value of the SCG, then the optimal CDRX configuration cycle is the MCG CDRX cycle.

At step 507, the method 500 may comprise transmitting the uplink data to a network entity over one of the MCG and SCG based on the optimal/improved/preferred CDRX configuration cycle. The step 505 is further explained in greater detail below with reference to FIGS. 6-8 and 10A-12.

FIG. 6 is a signal flow diagram illustrating example power management of a user equipment while transmitting intermittent UL data, according to various embodiments. As shown in FIG. 6, at step 602, the UE 601 is in dual connectivity such as multi-RAT dual connectivity (MRDC), with UL/DL split bearer. In an embodiment, the split bearer may correspond to any dual connectivity scenario such as E-UTRAN New Radio-Dual Connectivity (EN-DC), NE-DC, New Radio Dual Connectivity (NR-DC), any Multi-RAT Dual Connectivity (MR-DC), etc. Further, at step 604, the network has configured MCG 603 and SCG 605 with different CDRX cycle lengths because the MCG 603 and the SCG 605 are served using different gNBs/eNBs. For example, let us assume that the MCG CDRX cycle is smaller than the SCG CDRX cycle. In an embodiment, at step 604, the UE may detect the intermittent UL data pattern at the PDCP layer. In terms of UL data volume, below two different cases are considered intermittent data:
1) The total UL data volume to be transmitted is small and is below the predetermined threshold, e.g., ul-DataSplitThreshold or
2) The Total UL data volume to be transmitted is marginally larger than the predetermined threshold, e.g., ul-DataSplitThreshold.

In an embodiment, the UE may determine the volume of UL data based on at least one of an uplink data pattern and a frequency of PDCP SDU. In an embodiment, the frequency of PDCP data may refer to how frequently the PDCP data is received at the UE. In an embodiment, to determine the frequency of PDCP data, the UE can check which application is sending the PDCP data at what rate. For example, any streaming app may send the data continuously while any messaging app data would be intermittent. Accordingly, the UE may determine the UL data pattern and/or frequency of the PDCP SDU. Based on the determined the UL data pattern and/or frequency of the PDCP SDU, the UE may determine if the volume of the UL data is below the predetermined threshold. Accordingly, the UE may determine that the first parameter is met. Accordingly, as shown at steps 606 and 608, the UE may schedule the UL PDUs, e.g., UL data to the leg (MCG or SCG) with a smaller value of CDRX cycle. Further, as shown at steps 606 and 608, the UE may send a Release-16 UAI message with the preference for a longer CDRX value for the other leg. So, the disclosed techniques send the UL data which is generated intermittently through a smaller CDRX cycle leg and increases the CDRX cycle of the other leg using the Rel-16 UAI DRX-preference option.

In an embodiment, the stack with a smaller CDRX cycle length is used for transmission and the other stack sleep period is extended so will be in the off state. Thus, the present disclosure saves power, and reduces the protocol stack wake-up and power consumption, thereby enhancing the battery life.

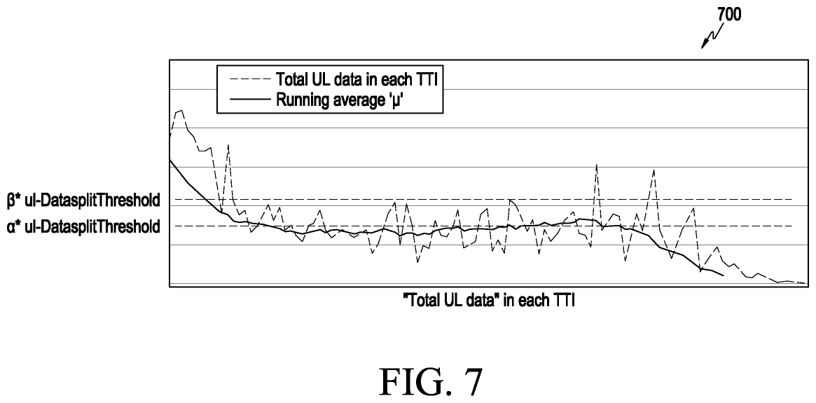

FIG. 7 is a graph 700 illustrating transmitted intermittent UL data in a CDRX configuration, according to various embodiments. As shown in FIG. 7, once the UL data volume, e.g., running average “μ” is lower than the predetermined threshold, e.g., α*ul-DataSplitThreshold volume, then at this transmission time interval (TTI), the UE detects that intermittent UL application data is to be transmitted. Based on the intermittent data detection, the UE may send UL data in a leg with a smaller value of CDRX cycle and for the other leg, the UE may trigger UAI release-16 with the longer value of CDRX preference. Hence, power is saved with the disclosed techniques compared to both stacks being in wake mode.

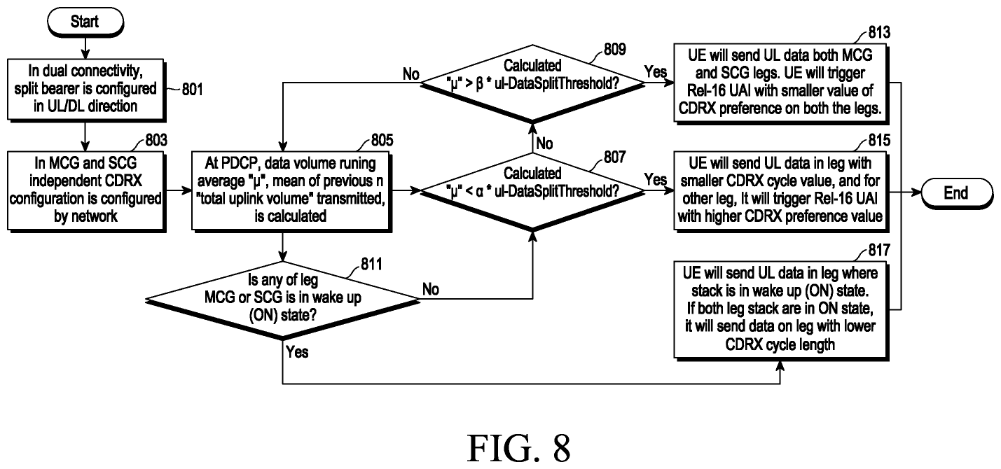

FIG. 8 is a flowchart illustrating an example method 800 for power management of a UE in a multi-RAT MR-DC state, according to various embodiments. At step 801, the UE is in dual connectivity, with UL/DL split bearer. At step 803, the network has configured MCG and SCG with different CDRX cycle lengths. At step 805, at the PDCP layer, the UE determines the volume of the UL data, e.g., a running average, “μ” of UL data volume. In an embodiment, the UE may determine the volume of UL data based on at least one of an uplink data pattern and a frequency of PDCP SDU. For example, the UE may determine the value of “μ” based on the previous N number of instances of “total UL data”. In an embodiment, the UL data is the intermittent data to be transmitted by the UE during the CDRX configuration. At step 807, it is determined that the value of “μ” is below the predetermined threshold, e.g., “α*ul-DataSplitThreshold”. If yes, then the method moves to step 815. Accordingly, the UE may determine that the first parameter is met. At step 815, the UE may transmit the UL data in a leg with a smaller value of the CDRX cycle. For example, the UE may determine an optimal CDRX configuration cycle among the MCG and the SCG by comparing the CDRX cycle value of the MCG leg and the SCG leg. In an embodiment, the network may provide the UE with the CDRX cycle value of the MCG leg and the SCG leg at the time of configuring the UE with the MCG and SCG leg. Further, the UE may trigger UAI release-16 with the longer value of CDRX preference for the other leg. Hence, the UE may transmit a request to the network entity for modifying one of the values of the CDRX configuration cycle of the MCG or the SCG and the request corresponds to a modification of the CDRX configuration cycle other than the optimal CDRX configuration. For example, if the UE determines the MCG leg as the optimal CDRX configuration cycle, then the UE may transmit the UL data on the MCG leg and may request the network to modify the CDRX cycle value of the SCG leg. Accordingly, the UE may trigger UAI release-16 with longer value, e.g., a modified value of CDRX preference for the SCG leg. However, if at step 807, it is determined that the value of “μ” is not below the predetermined threshold, then, the method 800 moves to step 809. At step 809, it is determined if calculated “μ”>β*ul-DataSplitThreshold, wherein “α” and “β” are used as multiplication scalers (hyperparameter threshold values) to determine the data volume threshold. If the UL data volume, μ, is more than the ul-DataSplitThreshold (configured by network in RRC reconfig) then the UE needs to follow as per 3GPP. β is a multiplicative factor used to check for uplink threshold value. If yes, then the method 800 moves to step 813. At step 813, the UE may send UL data on both legs, and it may trigger UAI release-16 with a smaller value of CDRX preference in both the legs. However, if at step 809, it is determined that the calculated “μ”<β*ul-DataSplitThreshold, then the method 800 moves back to step 805. Further, in an embodiment, after step 805, simultaneous to step 807, at step 811, it is determined if one of the MCG or SCG legs is in CDRX wake-up state (ON state). If yes, then the method moves to step 817. At step 817, the UE may schedule UL data on the leg which is already in a wake-up state such as the MCG leg, if the MCG leg is in a wake-up state. If both leg stacks are in the ON state, the UE may send data on the leg with a smaller value of CDRX cycle length. However, if the result of the determination at step 811 is no, then the method 800 moves to step 807 and the method 800 continues. Further, it should be noted that the two threshold value “α” and “β” are used to avoid frequent changes in CDRX cycle length. Hence, the UE may send intermittent UL data on the lower CDRX leg in split bearer case and indicate the network to modify the CDRX of the other leg to a larger value using the “drx-Preference-r16” element of Release-16 UE Assistance Information to save power. Hence, the disclosed techniques may use R16-based UAI to perform the disclosed methods.

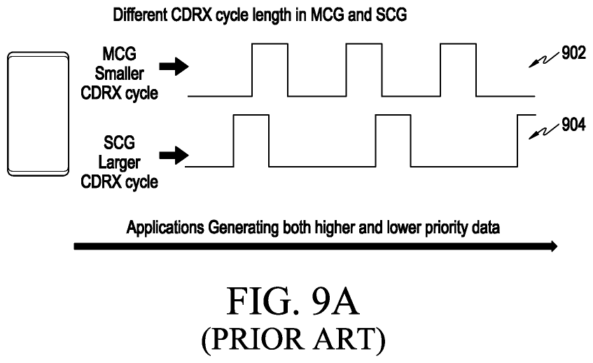

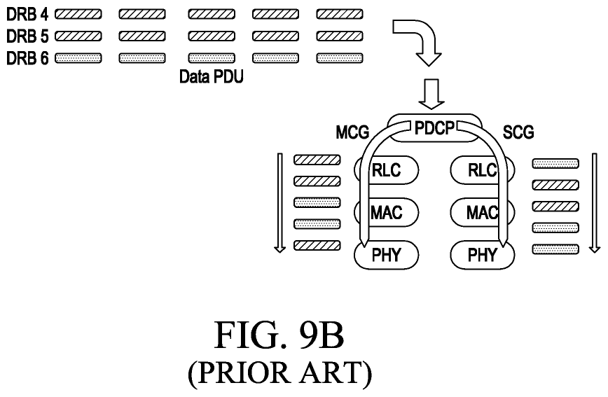

FIG. 9A is a diagram illustrating the CDRX cycle configuration for MCG and SCG leg for transmission of priority UL data, in accordance with existing art. FIG. 9B is a diagram illustrating the transmission of priority UL data in CDRX configuration, in accordance with existing art. In an example, the UE is in dual connectivity with UL/DL split bearer with different CDRX cycle lengths in MCG 902 and SCG 904, as shown in FIG. 9A. Higher and lower-priority applications are running on the UE generating packets of higher and lower priority. An application processor (AP) sends the application data to the modem which is mapped to one of the data radio bearers (DRBs), as shown in FIG. 9B. The network decides the DRB configuration based on agreed QoS and Guaranteed Bit Rate (GBR) values. The uplink packets fall into higher priority buckets and lower priority buckets depending upon QoS and GBR associated with PDUs. To transmit UL data, the UE sends the scheduling request (SR) or Buffer Status Report (BSR) to the network without considering any CDRX. For uplink transmission, the predetermined threshold, e.g., ul-DataSplitThreshold is considered before deciding the leg (MCG or SCG) through which UL transmission should happen for the volume of UL data till ul-DataSplitThreshold is met. So, when a higher priority UL data comes to the modem then it is possible that higher priority data get transmitted through a leg having a higher CDRX cycle, which could result in packet latency on the higher side further translating to poor Quality of Experience (QoE). Based on the volume of UL data and ul-Data SplitThreshold, PDCP decides the leg on which data to be transmitted. Further, as shown in FIG. 9B, DRB 6 has high-priority data but PDUs of DRB 6 are transmitted through the SCG leg, which has a higher length of CDRX cycle. Hence, this may result in packet latency in transmitting the higher priority.

In an embodiment, the present disclosure addresses the problem discussed in reference to FIGS. 9A and 9B, which are discussed in greater detail below with reference to FIGS. 10A-12. FIG. 10A is a diagram illustrating example CDRX cycle configuration for MCG and SCG leg for transmission of priority UL data, according to various embodiments. FIG. 10B is a diagram illustrating example transmission of priority UL data in CDRX configuration, according to various embodiments. In an embodiment, the UE is in dual connectivity with UL/DL split bearer. The network has configured MCG and SCG with different CDRX cycle lengths 1002, 1004 because MCG and SCG are served using different gNBs/eNBs, as shown in FIG. 10A. For example, let us assume that the MCG CDRX cycle is smaller than the SCG CDRX cycle. In an embodiment, based on the application data priority level, the UE may prioritize the UL transmission of higher priority level PDUs through the smaller CDRX cycle leg, e.g., the MCG leg and the lower priority level PDUs with the higher CDRX cycle length, e.g., the SCG leg. For example, as shown in FIG. 10B, some higher priority level services are pushing data in Data Radio Bearer (DRB) 6. Hence, PDUs of DRB 6 are of higher priority value so DRB6 packets are being transmitted via the MCG leg which has CDRX of shorter length. Hence, based on the priority level of UL data, PDCP decides the leg on which data to be transmitted.

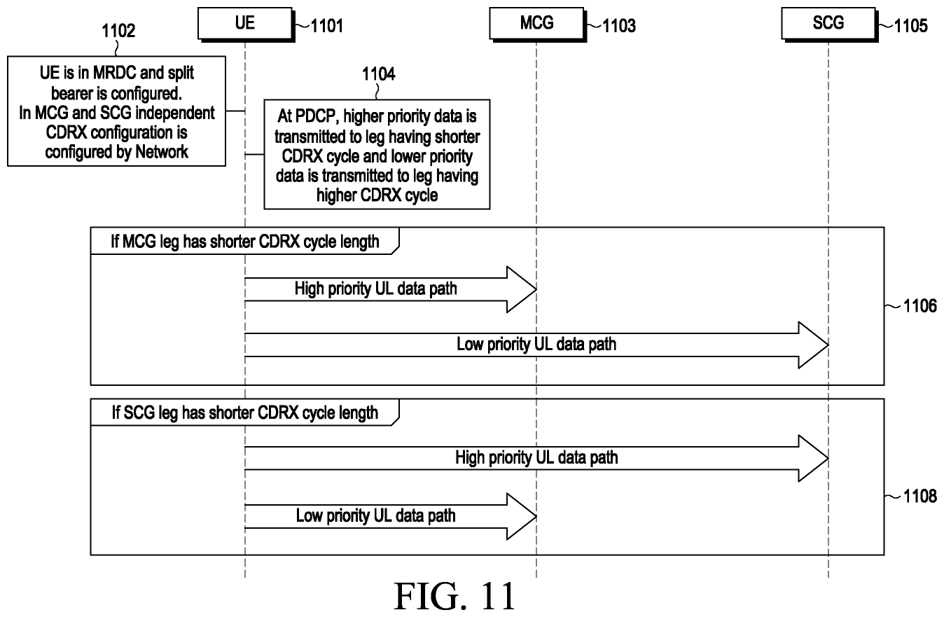

FIG. 11 is a signal flow diagram illustrating example data PDU scheduling in CDRX configuration, according to various embodiments. As shown in FIG. 11, the UE 1101 is in dual connectivity with UL/DL split bearer. At step 1102, the network has configured MCG and SCG with different CDRX cycle lengths because MCG 1103 and SCG 1105 are served using different gNBs/eNBs. For example, let us assume that the MCG CDRX cycle is smaller than the SCG CDRX cycle. In an embodiment, as shown at step 1004, the UE 1101 may prioritize the UL transmission of higher priority level PDUs through smaller CDRX cycle legs and the lower priority level PDUs with higher CDRX cycle length. In an embodiment, a higher-priority application generates high-priority level PDUs. Similarly, low-priority applications may generate PDUs of lower priority levels. At the PDCP layer, both PDUs with higher and lower priority are transmitted either to the MCG leg or to the SCG leg. As shown in FIG. 11 at step 1106, the higher priority value UL data is being transmitted via the MCG leg which has CDRX of shorter length. On the other hand, if the MCG leg has a shorter CDRX value, then, as shown at step 1108, the higher priority value UL data is being transmitted via the SCG leg.

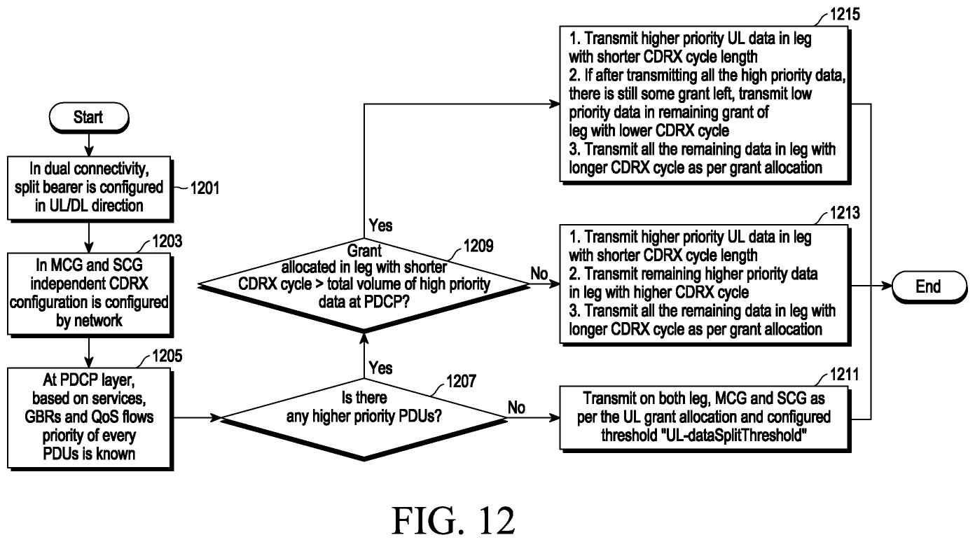

FIG. 12 is a flowchart illustrating an example method for power management of a UE in a multi-RAT MR-DC state, according to various embodiments. As shown in FIG. 12, at step 1201, the UE is in dual connectivity with UL/DL split bearer. At step 1203, the network has configured MCG and SCG with different CDRX cycles. At step 1205, at the PDCP layer, the GBRs and QoS flows priority level of every PDU is determined based on applications running on the UE. Hence, at step 1205, a priority level of each of the PDU, e.g., UL data is determined. In an embodiment, the priority level of the uplink data is determined based on at least one of the QCI and the GBR values associated with the uplink data. At step 1207, it is determined if there are any higher priority PDUs at PDCP. In other words, at step 1207, it is determined if the priority level of the uplink data is above a predetermined priority level. In an embodiment, the UE may define the predetermined priority level of the UL data based on the type of UL data. In an embodiment, the UE may define the predetermined priority level of the UL data based on the type of application related to the UL data. In an embodiment, the predetermined priority level of the UL data may be predefined by the applications running on the UE. If yes, then it is determined that the second parameter is met, and the method 1200 moves to step 1209. However, if the second parameter is not met at step 1207, then the method 1200 moves to step 1211. At step 1211, the UL data is transmitted on both the legs, e.g., MCG and SCG leg as per the UL grant allocation, and are configured through “ul-datasplitThreshold”. At step 1209, it is determined if sufficient UL grant in the MCG leg is allocated so that all high-priority level PDUs can be transmitted through the MCG leg. For example, it is determined if the grant value of the uplink data in the optimal CDRX configuration cycle, e.g., MCG leg, is greater than a volume of uplink data with the priority level above the predetermined priority level. If yes, then, at step 1215, the higher priority level UL data is transmitted in the optimal CDRX configuration cycle, e.g., MCG leg, as the MCG leg has a shorter CDRX cycle length than the SCG leg. Further, the low-priority level data is also transmitted in the remaining MCG UL grant. However, if there is still some UL data remaining to be transmitted and the UL grant of the MCG leg is completed, then the remaining UL data is transmitted in the SCG leg, which has a longer CDRX cycle length, as per UL grant allocation in SCG leg. However, if the result of the determination at step 1209 is no, then the method 1200 moves to step 1213. At step 1213, the higher priority level UL data is transmitted in the optimal CDRX configuration cycle, e.g., MCG leg till the UL grant of the MCG leg is completed. Then, the reaming high-priority level UL data is transmitted using the SCG UL grant, which has a longer CDRX cycle length. Also, low-priority data is transmitted in the SCG UL grant.

Hence, when different applications having different data priority levels are running on the UE, then the UE may send the UL data corresponding to the highest priority level on the shorter CDRX leg in the split bearer case. Accordingly, the UE may reduce the latency of application data and CDRX preference as per priority level type ensuring the less wake during CDRX sleep and thus resulting in power saving of the UE.

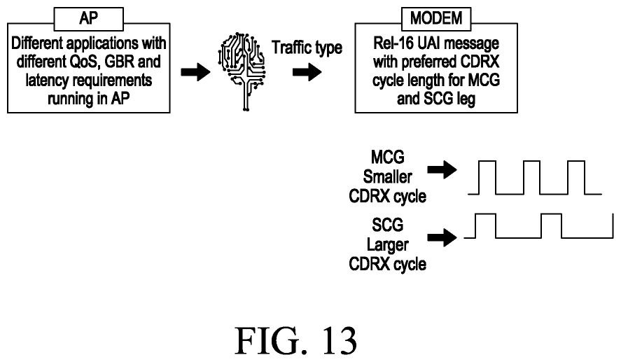

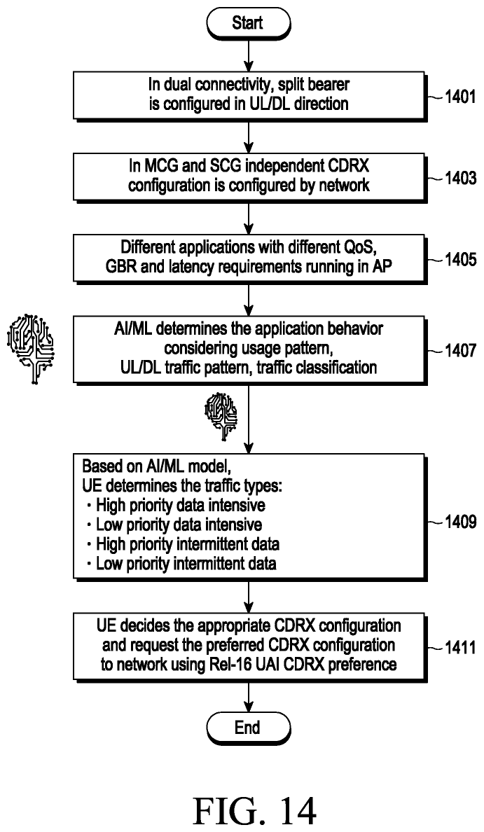

In an embodiment, the description with reference to FIGS. 5-14 may be performed using Artificial Intelligence (AI)/Machine Learning (ML). FIG. 13 is a block diagram illustrating the use of Artificial Intelligence (AI)/Machine Learning (ML) to determine a preferred CDRX from a network, according to various embodiments. As shown in FIG. 13, artificial intelligence/machine learning may be used to determine preferred CDRX from Network based on UE traffic. FIG. 14 is a flowchart illustrating an example method for determining a preferred CDRX from a network using AI/ML, according to various embodiments. As shown in FIG. 14, at step 1401, the UE is in dual connectivity with UL/DL split bearer. At step 1403, the network has configured MCG and SCG with different CDRX cycle lengths because MCG and SCG are served using different gNBs/eNBs. At step 1405, various types of applications are running in UE with different QoS, GRBs, latency requirements, and usage preferences. At step 1407, the AI/ML may determine user behavior and UL/DL traffic, traffic type classification, etc. At step 1409, using AI/ML, the UE may determine traffic such as high-priority data-intensive, high-priority intermittent data, low-priority data-intensive, and low-priority intermittent data. At step 1411, once the traffic types are determined using AI/ML module, the UE may check the appropriate CDRX configuration corresponding to each of the applications. Further, based on the determination of traffic type and its CDRX configuration, when an already classified application is running, then the UE may request the network for determined CDRX configuration using Release-16 UE Assistance Information (UAI) message with the preferred value of CDRX cycle length for MCG and SCG leg. Thus, this embodiment may reduce the overall latency of the application and wake-up cycle (stack state ON to OFF or stack state OFF to ON). Thus, QoS and battery of the UE are enhanced.

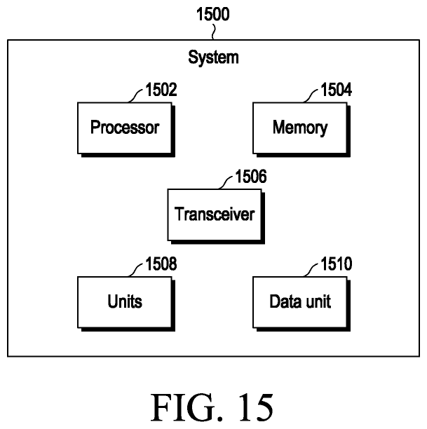

FIG. 15 is a block diagram illustrating an example configuration of a UE 1500 for power management in an MR-DC state, according to various embodiments. It should be noted that the UE 1500 may be a part of a UE. In an embodiment, the UE 1500 may be connected to the UE. The UE 1500 may include but is not limited to, a processor (e.g., including processing circuitry) 1502, a memory 1504, a transceiver (e.g., including transmitting/receiving circuitry) 1506, units 1508, and data unit 1510. The units 1508 and the memory 1504 may be coupled to the processor 1502. The UE 1500 may be configured to perform methods as described above with reference to FIGS. 5-12. The transceiver 1506 may be configured to transmit the optimized and/or default scaling factor and receive the first and/or second set of network resources.

The processor 1502 can be a single processing unit or several units, all of which could include multiple computing units. The processor 1502 may be implemented as one or more microprocessors, microcomputers, microcontrollers, digital signal processors, central processing units, state machines, logic circuitries, and/or any UEs that manipulate signals based on operational instructions. Among other capabilities, the processors 1502 are configured to fetch and execute computer-readable instructions and data stored in the memory 1504, respectively.

The memory 1504 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The units 1508 amongst other things include routines, programs, objects, components, data structures, etc., which perform particular tasks or implement data types. The units 1508 may also be implemented as, signal processor(s), state machine(s), logic circuitries, and/or any other UE or component that manipulates signals based on operational instructions.

Further, the units 1508 can be implemented in hardware, instructions executed by a processing unit (e.g. processor including various processing circuitry), or by a combination thereof. The processing unit can comprise a computer, a processor, such as the processor 1502, a state machine, a logic array, or any other suitable UEs capable of processing instructions. The processing unit can be a general-purpose processor which executes instructions to cause the general-purpose processor to perform the required tasks or, the processing unit can be dedicated to performing the required functions. In an embodiment of the present disclosure, the units 1508 may be machine-readable instructions (software) that, when executed by a processor/processing unit, perform any of the described functionalities.

The data unit 1510 serves, amongst other things, as a repository for storing data processed, received, and generated by one or more of the units 1508, respectively.

Accordingly, the present disclosure provides at least following technical advantages:

Using Release-16 DRX-Preference in UE Assistance Information message, the UE may modify the CDRX configurations for MCG or SCG leg depending on the nature of data from the application to reduce the wake-up and save power, thereby enhancing the battery life of the UE.

When different applications having different data priorities are running on the UE, the UE may send the UL data corresponding to the highest priority on the shorter CDRX leg in the split bearer case, thereby ensuring the reduction of protocol stack wake-up and reducing the power consumption.

The use of AI/ML helps the UE to determine the application type, based on which UE can modify the CDRX values. This enables the UE to achieve lower power consumption.

The disclosed techniques enable UE to achieve lower power consumption with different types of application and data.

The disclosed techniques minimize and/or reduce power consumption in UE with proper identification and application of CDRX values to enhance user experience.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

Benefits, other advantages, and solutions to problems have been described above with regard to various example embodiments. However, the benefits, advantages, addressing of problems, and any component(s) that may cause any benefit, advantage, or solution to occur or become more pronounced are not to be construed as a critical, required, or essential feature or component of any or all the claims.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for power management of a user equipment (UE) in a wireless communication system supporting a multi-radio access technology (RAT) dual connectivity (MR-DC) state, comprising:
determining whether one of a first parameter or a second parameter is met, wherein each of the first parameter and the second parameter relates to an uplink data to be transmitted by the UE, based on the UE being in the MR-DC state;
comparing, based on one of the first parameter or the second parameter being met, a value of a connected mode discontinuous reception (CDRX) configuration of a master cell group (MCG) cycle and a value of CDRX configuration cycle for a secondary cell group (SCG) cycle, wherein the UE is in the MR-DC state with the MCG and SCG;
determining a CDRX configuration cycle among the MCG and the SCG based on a result of the comparison; and
transmitting the uplink data to a network entity over one of the MCG and SCG based on the determined CDRX configuration cycle.

2. The method as claimed in claim 1, further comprising:
transmitting a request to the network entity for modifying one of the value of the CDRX configuration cycle of the MCG or the value of the CDRX configuration cycle of the SCG, wherein the request corresponds to a modification of the CDRX configuration cycle other than the determined CDRX configuration.

3. The method as claimed in claim 1, wherein the first parameter corresponds to a volume of the uplink data and the second parameter corresponds to a priority level of the uplink data.

4. The method as claimed in claim 1, wherein determining whether the one of the first parameter and the second parameter is met, comprises:
determining that the first parameter is met in case that a volume of the uplink data is below a specified threshold value, wherein the volume of the uplink is based on at least one of an uplink data pattern and a frequency of packet data convergence protocol service data unit (PDCP SDU).

5. The method as claimed in claim 1, wherein determining whether one of the first parameter and the second parameter is met, comprises:
determining that the second parameter is met in case that a priority level of the uplink data is above a specified priority level, wherein the priority level of the uplink data is determined based on at least one of a QoS Class Identifier (QCI), and a guaranteed bit rate (GBR) value associated with the uplink data.

6. The method as claimed in claim 1, wherein the determined CDRX configuration cycle corresponds to one of the MCG and SCG having a lower CDRX cycle value.

7. The method as claimed in claim 1, wherein transmitting the uplink data, in case that the first parameter is met, comprises:
determining whether one of an MCG stack and an SCG stack is in an awake state; and
transmitting the uplink data over one of the MCG and SCG based on the determination.

8. The method as claimed in claim 1, wherein transmitting the uplink data, in case that the second parameter is met, comprises:
determining if a grant value of uplink data in the determined CDRX configuration cycle is greater than a volume of uplink data with the priority level above the specified priority level; and
transmitting the uplink data with the priority level below the specified priority level over the determined CDRX configuration.

9. A user equipment (UE) in a wireless communication system supporting a multi-radio access technology (RAT) dual connectivity (MR-DC) state, comprising:
a transceiver; and
a processor configured to:
determine whether one of a first parameter or a second parameter is met, wherein each of the first parameter and the second parameter relates to an uplink data to be transmitted by the UE, based on the UE being in the MR-DC state,
compare, based on one of the first parameter or the second parameter being met, a value of a connected mode discontinuous reception (CDRX) configuration of a master cell group (MCG) cycle and a value of CDRX configuration cycle for a secondary cell group (SCG) cycle, wherein the UE is in the MR-DC state with the MCG and SCG,
determine a CDRX configuration cycle among the MCG and the SCG based on a result of the comparison, and
transmit, through the transceiver, the uplink data to a network entity over one of the MCG and SCG based on the determined CDRX configuration cycle.

10. The UE as claimed in claim 9, wherein the processor is configured to:
transmit, through the transceiver, a request to the network entity for modifying one of the value of the CDRX configuration cycle of the MCG or the value of the CDRX configuration cycle of the SCG, wherein the request corresponds to a modification of the CDRX configuration cycle other than the determined CDRX configuration.

11. The UE as claimed in claim 9, wherein the first parameter corresponds to a volume of the uplink data and the second parameter corresponds to a priority level of the uplink data.

12. The UE as claimed in claim 9, wherein for determining whether the one of the first parameter and the second parameter is met, the processor (1502) is configured to:
determine that the first parameter is met in case that a volume of the uplink data is below a specified threshold value, wherein the volume of the uplink is based on at least one of an uplink data pattern and a frequency of packet data convergence protocol service data unit (PDCP SDU).

13. The UE as claimed in claim 9, wherein for determining whether one of the first parameter and the second parameter is met, the processor is configured to:
determine that the second parameter is met in case that a priority level of the uplink data is above a specified priority level, wherein the priority level of the uplink data is determined based on at least one of a QoS Class Identifier (QCI), and a guaranteed bit rate (GBR) value associated with the uplink data.

14. The UE as claimed in claim 9, wherein the determined CDRX configuration cycle corresponds to one of the MCG and SCG with a lower CDRX cycle value.

15. The UE as claimed in claim 9, wherein for transmitting the uplink data, in case that the first parameter is met, the processor is configured to:
determine whether one of an MCG stack and a SCG stack is in an awake state; and
transmit the uplink data over one of the MCG and SCG based on the determination.

16. The UE as claimed in claim 9, wherein for transmitting the uplink data, in case that the second parameter is met, the processor is configured to:
determine whether a grant value of uplink data in the determined CDRX configuration cycle is greater than a volume of uplink data with the priority level above the specified priority level; and
transmit, through the transceiver, the uplink data with the priority level below the specified priority level over the determined CDRX configuration.
